(19) United States
(12) Patent Application Publication
(10) Pub. No.: US 2004/0228229 A1
(43) Pub. Date: Nov. 18, 2004

(54) Lens drive apparatus, optical head apparatus, and optical disk drive apparatus

(75) Inventors: Fumisada Maeda, Tokyo (JP); Tomoyuki Ishida, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/790,820

(22) Filed: Mar. 3, 2004

(30) Foreign Application Priority Data
Mar. 17, 2003 (JP) 2003-071674

(51) Int. Cl. G11B 7/00

(52) U.S. Cl. 369/44.16

(57) ABSTRACT

For moving an objective lens in its optical axis direction and its tracking direction perpendicular to the optical axis direction, a lens drive apparatus includes a movable section to which a focus coil and a tracking coil are annexed, and a fixed section for supporting the movable section. The fixed section includes magnetic field units correspondingly to coils. The axis of inertia (z-axis) passing through the center of gravity of the movable section is accorded with the optical axis of the objective lens, and the tracking coil is provided on a side surface of the movable section on one side in the x-axis direction (the linear velocity direction of a disk), and the focus coil is provided on the side surface on the other side. The center of gravity of the movable section and the driving center are regulated at positions sifted from each other in the x-axis direction.

### CROSS REFERENCE TO RELATED APPLICATION

This application claims priority from Japanese Priority Document No. 2003-071674, filed on Mar. 17, 2003 with the Japanese Patent Office, which document is hereby incorporated by reference.

### BACKGROUND OF THE INVENTION

1. Field of the Invention

The present invention relates to a technique for a lens drive apparatus and an optical head apparatus to be used for the reproduction or the recording of information of the optical disk, and more particularly to a technique adopting a configuration form in which the center of gravity of a movable section mounting an objective lens thereon and the driving center of the movable section do not accord with each other in a linear velocity direction of an optical disk, and in which the optical axis of the lens accords with the axis of inertia of the movable section, for decreasing the influence of unnecessary resonance around the axis of inertia on servo errors.

2. Description of the Related Art

In an disk drive apparatus using an optical recording medium such as an optical disk and a magneto-optical disk, an optical pickup is used as means for reading a recorded information signal, and focus servo control and tracking servo control are performed by the control of an actuator (so-called two-axis actuator) constituting a drive apparatus of an objective lens.

Then, the driving actuator of the objective lens includes a movable section and a fixed section, and is configured, for example, to annex a focus coil and a tracking coil to the movable section mounted with the objective lens. The driving actuator is designed in order that the driving center of the objective lens may accord with the center of gravity of the movable section. The design aims to suppress motions other than a translation motion along a driving direction (for example, unnecessary resonance in a rotating direction, and the like). A configuration in which the position of the driving center of the objective lens in a focusing direction accords with the position of the center of gravity of the movable section is known (see, for example, Patent Document 1: Japanese Patent Application Laid-Open Publication No. Hei 9-180221).

However, the conventional configuration has many limitations on design for making the driving center of the movable section accord with the center of gravity thereof. The limitations are, for example, there is the necessity to arrange a plurality of coils symmetrically with the center of gravity of the movable section between them for performing a drive of the movable section into one direction, and the like. Consequently, the size of the movable section of the conventional configuration tends to become larger. As a result, the conventional configuration has a problem of difficulty of miniaturization in size and simplification in structure.

Moreover, in the conventional configuration, it is difficult to secure a coil length (the so-called effective length), which substantially contributes to a coil driving, sufficiently. Consequently, there are many disadvantageous cases on design from the viewpoint of the structure and the thrust thereof.

### SUMMARY OF THE INVENTION

It is an advantage of the present invention to provide a lens drive apparatus to be used for reading and recording the information of an optical recording medium which apparatus can realize to have high thrust and a wide band by using a magnetic circuit effectively without exerting any bad influence to focus servo control and tracking servo control.

For solving the problems described above, according to the present invention, a lens drive apparatus including a movable section to which a plurality of lens driving coils or magnetic field means is annexed, and a fixed section provided with magnetic field means to the driving coils or driving coils to the magnetic field means of the movable section, wherein the lens drive apparatus has the following configuration in which, a center of gravity of the movable section is positioned on an optical axis of a lens; and the center of gravity of the movable section and a driving center of the movable section are positioned with a shift between them in a direction perpendicular to the optical axis direction of the lens and to the moving direction of the movable section, as seen from the optical axis direction of the lens.

Consequently, according to the present invention, a design is not restricted to the necessity of according the driving center of the movable section with the center of gravity of the movable section as seen from the optical axis direction of the lens. Consequently, the freedom of designing a lens driving mechanism becomes high. Moreover, by positioning the center of gravity of the movable section on the optical axis of the lens, the influence of a rotation generated around the center of gravity of the movable section as their center and a vibration mode on lens driving control can be suppressed.

As it will be apparent from the above description, according to a first aspect of the present invention, a configuration in which the center of gravity of the movable section and the driving center of the movable section are not accorded to each other, and in which the optical axis of the lens and an axis of inertia of the movable section are accorded with each other, is adopted, and consequently, the freedom of design pertaining to a lens drive is high. Moreover, because the influence of unnecessary resonance owing to a rotation mode around the optical axis can be reduced, for example, the performance and the reliability of recording and reproducing in an application to an apparatus using an optical recording medium can be secured.

According to a second aspect of the present invention, the influence of a rotation mode around an x-axis can be suppressed, and stable lens drive control can be realized.

According to a third aspect of the present invention, it is possible to prevent the generation of a movement of a beam spot in the y-axis direction owing to the influence of the rotation mode around the x-axis.

According to a fourth aspect of the present invention, because a moving distance of a beam spot to be generated around a z-axis direction owing to a rotation mode around the y-axis is sufficiently small, the influence to be exerted on lens drive control in the z-axis direction can be neglected.

According to a fifth aspect of the present invention, a moving distance of a beam spot to be generated in the z-axis owing to the rotation mode around the y-axis becomes zero theoretically (namely, no influence is exerted on the lens drive control in the z-axis direction).

According to a sixth aspect of the present invention, a magnetic circuit formed by magnetic field means to the driving coils is effectively utilized to obtain high thrust, and a structure suitable for making a wide band, miniaturization and precise drive control can be realized.

### BRIEF DESCRIPTION OF THE DRAWINGS

FIG. 1 is a schematic view showing, together with FIG. 2, a basic configuration example of an optical disk drive apparatus according to the present invention as seen from an optical axis direction of an objective lens;

FIG. 2 is a schematic view of the basic configuration example as seen from a direction perpendicular to the optical axis direction of the objective lens;

FIG. 3A, 3B, 3C and 3D are views showing an example of a lens drive apparatus according to the present invention;

FIG. 4 is a view showing a side surface of a movable section and a focus coil, both constituting the lens drive apparatus of FIGS. 3A-3D;

FIG. 5 is a view showing another side surface of the movable section and a tracking coil, both constituting the lens drive apparatus of FIGS. 3A-3D;

FIG. 6 is a view for illustrating, together with FIGS. 7 to 11, a drive in a tracking direction by showing the principal part of the lens drive apparatus as seen from the optical axis direction of the objective lens;

FIG. 7 is an explanatory view showing the principal part of the lens drive apparatus when a center of gravity G is shifted from the optical axis direction as seen from a z-axis direction;

FIG. 8 is an explanatory view showing the principal part of the lens drive apparatus when the z-axis including the center of gravity G is accorded with the optical axis;

FIG. 9 is a view for illustrating a rotation around an x-axis by showing the side surface of the movable section as seen from an x-axis direction;

FIG. 10 is a group of graph diagrams exemplifying transfer characteristics pertaining to the tracking direction;

FIG. 11 is a group of graph diagrams for illustrating an open-loop transfer function when tracking servo control is applied;

FIG. 12 is a view for illustrating, together with FIGS. 13 to 17, a drive in a focusing direction by showing the principal part of the lens drive apparatus as seen from the x-axis direction;

FIG. 13A is a view showing the movable section as seen from a y-axis direction, and FIG. 13B is a schematic diagram showing a variation of a principal point of lens M in the z-axis direction;

FIG. 14A is a view showing the movable section as seen from the y-axis direction, and FIG. 14B is a schematic diagram showing an amplitude variation around a y-axis;

FIG. 15 is a graph diagram exemplifying again characteristic in the focusing direction;

FIG. 16 is a group of graph diagrams exemplifying transfer characteristics pertaining to the focusing direction; and

FIG. 17 is a group of graph diagrams for illustrating an open-loop transfer function when focus servo control is applied.

### DETAILED DESCRIPTION OF THE PREFERRED EMBODIMENTS

The present invention relates to a lens drive apparatus, and an optical head apparatus and an optical disk drive apparatus, both using the lens drive apparatus. The present invention can be applied to a disk system using a magneto-optical medium, a phase-change type medium, an organic dye medium, and the like. Incidentally, whether the kind of execution by the apparatus is the reproduction or the recording of information pertaining to a disk-like recording medium does not matter (any forms of a reproduction only apparatus, a recording and reproducing apparatus, and a recording only apparatus may be adopted).

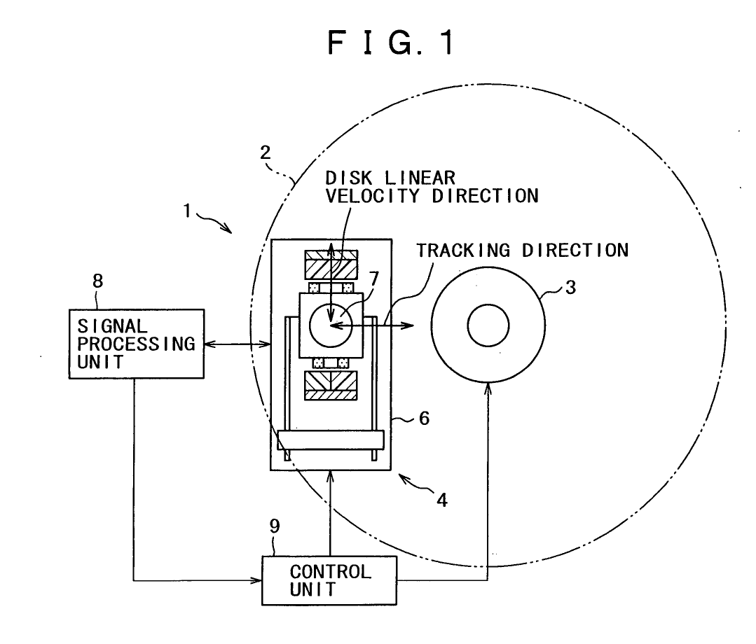

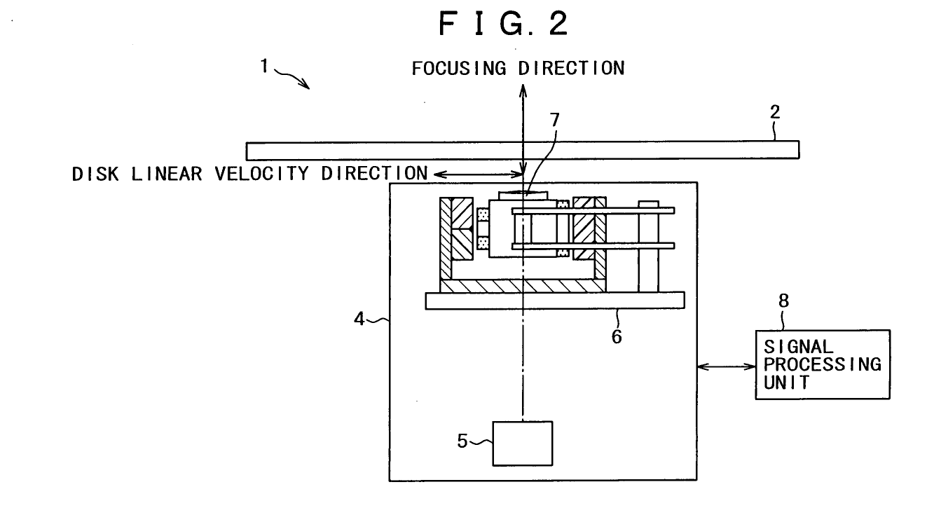

FIGS. 1 and 2 are schematic diagrams showing a basic configuration example of an optical disk drive apparatus according to the present invention. The optical disk drive apparatus 1 includes a spindle motor as rotation means 3 (see FIG. 1) for rotating an optical disk 2. Incidentally, as the optical disk (hereinafter simply referred to as “disk”) 2, a read only memory (ROM) medium for reading only, a random access memory (RAM) medium capable of being written and being accessed randomly, and the like can be cited.

An optical head apparatus 4 is provided for performing the recording or the reproduction of information pertaining to the disk 2. As shown in FIG. 2, the optical head apparatus 4 includes a light source 5 (or light emitting and receiving integrated type optical element including a laser light source and light receiving means, and the like) provided for photo-irradiation to the disk 2.

In the present embodiment, a lens drive apparatus 6 is used for driving an objective lens 7 constituting an optical system together with the light source 5. The lens drive apparatus 6 is configured as the so-called two-axis actuator. For example, a plurality of driving coils for moving a mounted lens (objective lens) in an optical axis direction thereof and a movement direction perpendicular to the optical axis direction is annexed to a movable section of the lens drive apparatus 6, and a fixed section for supporting the movable section is provided with magnetic field means (such as a magnet and a yoke) to the driving coils (the details of the magnetic field means will be described later).

Return light from the disk 2 is detected by a not shown light receiving unit, and is transmitted to a signal processing unit 8. Incidentally, the signal processing unit 8 performs demodulation processing of reproduced data, modulation processing of recording data, error correcting code (ECC) processing, decoding processing of address information, and the like.

A control unit 9 performs drive control (spindle servo control) of a spindle motor constituting the rotation means 3, position control of the optical head apparatus 4 in a radial direction of the disk 2, and focus servo control and tracking servo control of the objective lens 7, and the like. In addition, a power control circuit of the laser light source, and the like is included in the control unit 9.

The lens drive apparatus 6 according to the present invention has a form in which a center of gravity of its movable section does not accord with centers of drive in a focusing direction and in a tracking direction in a linear velocity direction of the disk (i.e. in a tangential direction along a rotating direction of the disk), but in the form, an optical axis of the lens is accorded with an axis of inertia of the movable section. Thereby, influence on open-loop transfer characteristics of focus servo control and tracking servo control caused by resonance around the axis of inertia is decreased, and efficiency of use of a magnetic circuit including the magnetic field means is secured. Consequently, high thrust and a wide band can be realized.

Then, as embodiments of the lens drive apparatus 6, the following two forms can be cited: (I) a configuration form in which the driving coils are provided in the movable section and the magnetic field means (such as the magnet) is provided in the fixed section supporting the movable section (the so-called “moving coil (MC) type”), and (II) a configuration form in which the magnetic field means is provided in the movable section and the driving coils are provided in the fixed section supporting the movable section (the so-called “moving magnet (MM) type”).

Both of the forms may be adopted in the application of the present invention, but in the following, the form (I) will be described.

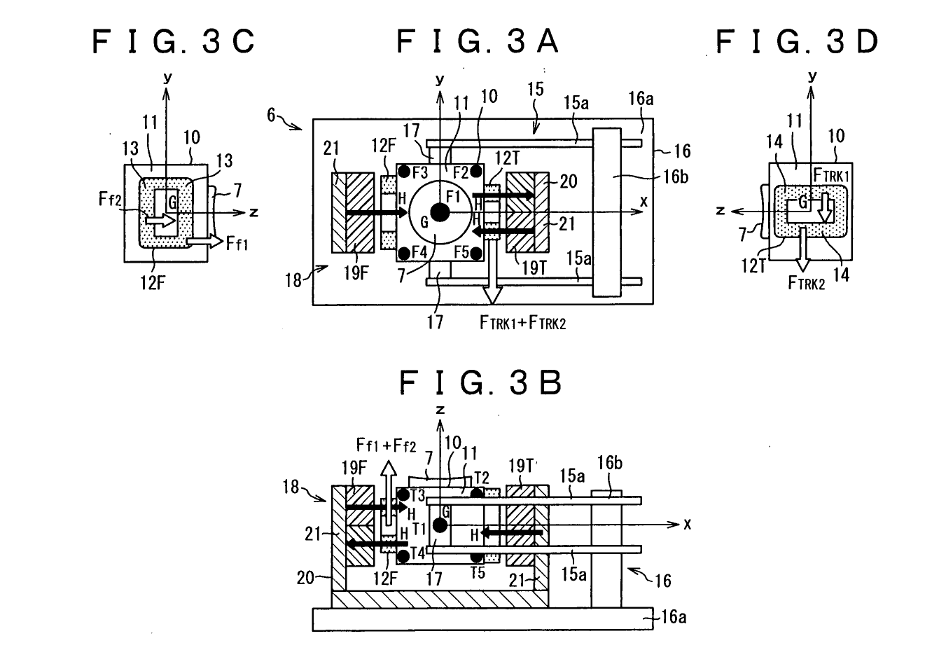

FIGS. 3A-3D show schematic diagrams showing an example of implementation of the lens drive apparatus 6. As to setting of a three-dimensional Cartesian coordinate system indicated by x, y and z, a z-axis is set to pass through the center of gravity of the movable section 10 in a direction parallel to the optical axis; a y-axis is set in the tracking direction pertaining to movement of the lens; and an x-axis is set in the linear velocity direction of the disk which is perpendicular to the z-axis and the y-axis. The center of gravity “G” of the movable section 10 is selected as the origin of the Cartesian coordinate system. Incidentally, among FIGS. 3A-3D, FIG. 3A shows a plan view of the movable section 10 and the fixed section 16 as seen from a z-axis direction; FIG. 3B shows a side view of the movable section 10 and the fixed section 16 as seen from a y-axis direction; FIGS. 3C and 3D severally show a side view of the movable section 10 as seen from different direction in an x-axis direction.

The movable section 10 constituting the objective lens actuator shown in the present embodiment includes a principal piece (bobbin) 11 made of a synthetic resin in almost a rectangular parallelepiped. The objective lens 7 is provided on one surface perpendicular to the z-axis among the side surfaces of the principal piece 11. Driving coils 12F and 12T are annexed on side surfaces perpendicular to the x-axis with the objective lens 7 in-between. That is, the driving coil 12F is set as a focus coil (a driving coil in the focusing direction), and is fixed on one side surface perpendicular to the x-axis among the side surfaces of the principal piece 11, as shown in FIG. 3C. The other driving coil 12T is set as a tracking coil (a driving coil in the tracking direction), and is fixed on a side surface positioned on the opposite side of the side surface on which the focus coil 12F is provided with the objective lens 7 in-between. The side surface on which the tracking coil 12T is provided is one of the side surfaces perpendicular to the x-axis among the side surfaces of the principal piece 11, as shown in FIG. 3D.

As described above, the focus coil 12F and the tracking coil 12T are arranged on the side surfaces on the opposite side of each other on the principal piece 11. Each coil is formed of a coil wire wound in a rectangle shape. Incidentally, as to the focus coil 12F, as shown in FIG. 3C, the long sides 13 thereof are arranged along the y-axis direction. As to the tracking coil 12T, as shown in FIG. 3D, the long sides 14 thereof are arranged along the z-axis direction. Incidentally, marks “F_{f1}” and “F_{f2}” indicated by an arrow severally in FIG. 3C severally designate a piece of driving force (pieces of force in a positive direction of the z-axis) to be generated in the long sides 13 when a current is made to flow in a certain direction through the focus coil 12F. A mark “F_{f1}+F_{f2}” indicated by an arrow in FIG. 3B designates resultant force of the driving force “F_{f1}” and the driving force “F_{f2}” (pieces of driving force in the focusing direction) Moreover, marks “F_{TRK1}” and “F_{TRK2}” indicated by an arrow severally in FIG. 3D severally designate a piece of driving force (pieces of force in a negative direction of the y-axis) to be generated in the long sides 14 when a current is made to flow in a certain direction through the tracking coil 12T. A mark “F_{TRK1}+F_{TRK2}” indicated by an arrow in FIG. 3A designates resultant force of the driving force “F_{TR1}” and the driving force “F_{TRK2}” (pieces of driving force in the tracking direction) Then, arrows indicated severally by a mark “H” in FIGS. 3A and 3B designate the directions of magnetic fields owing to magnets, which will be described later.

The movable section 10, to which those driving coils 12F and 12T are annexed, is supported to a fixed section 16 by support means 15. The fixed section 16 includes a base section 16a and a holding section 16b formed to stand on the base section 16a. In the present embodiment, the movable section 10 is supported by a suspension (suspension means) using a plurality of support members 15a formed of elastic materials. Every two support members 15a of the four support members 15a are combined to a couple. Ends of one couple of the support members 15a on one side are fixed to a mounting section 17 provided on one side surface (the side surface perpendicular to the y-axis) of the principal piece 11. Ends of the other couple of the support members 15a on the same side as that of the ends of the former couple are fixed to another mounting section 17 provided on another side surface (the other side surface perpendicular to the y-axis) of the principal piece 11. Then, the ends of all of the support members 15a on the other side are fixed to the holding section 16b to be held. Incidentally, because the support structure of the movable section 10 does not matter in the application of the present invention, configuration forms, not only using metal wires, plate springs and the like, but also using the other various support members, can be adopted.

Magnets 19F and 19T and a yoke 20 are provided in the fixed section 16 as magnetic field means 18 of the driving coils 12F and 12T. That is, the yoke 20 is shaped in a letter U as seen from the y-axis direction, as shown in FIG. 3B. The magnets 19F and 19T are provided on inner surfaces (surfaces on the side of the movable section 10) of parts 21 opposed to each other in the x-axis direction. The magnet 19F is a focusing magnet opposed to the focus coil 12F, and the magnet 19T is a tracking magnet opposed to the tracking coil 12T. Both the magnets 19F and 19T for generating magnetic fields to each of the coils 12F and 12T are polarized in two poles. That is, the magnets 19F and 19T severally take the following polarization forms. As shown in FIG. 3B, the focusing magnet 19F is divided into two poles by being divided into two parts in the z-axis direction. On the other hand, as shown in FIG. 3A, the tracking magnet 19T is divided into two poles by being divided into two parts in the tracking direction (the y-axis direction).

As described above, in the present embodiment, the magnets 19F and 19T provided to the driving coils 12F and 12T, respectively, are arranged to be opposed to each other with the objective lens 7 in-between.

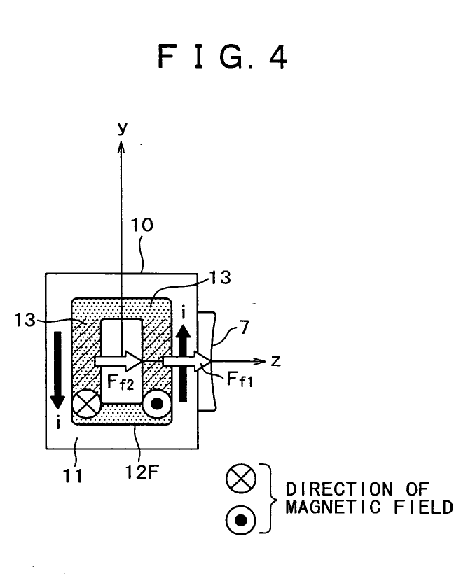

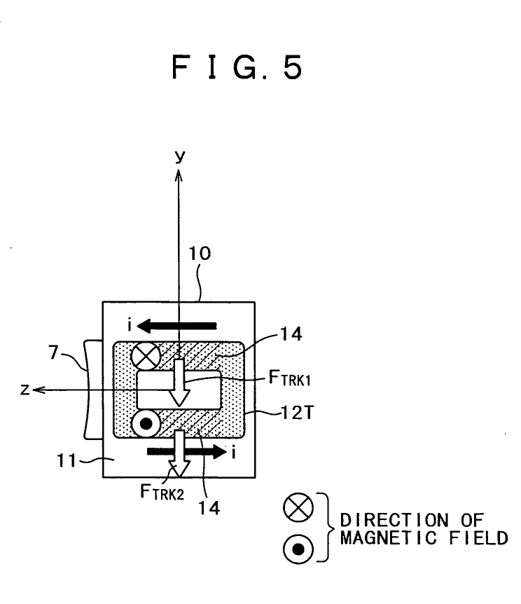

FIG. 4 shows the side surface of the movable section 10 and the focus coil 12F annexed to the side surface as seen from the x-axis direction. Moreover, FIG. 5 shows the side surface of the movable section 10 and the tracking coil 12T annexed to the side surface as seen in the x-axis direction. Incidentally, in these drawings, an arrow indicated by a letter “i” designates the direction of a drive current flowing through each coil side. Moreover, a sign formed of “x” or “∘” in a circle designates a direction of a magnetic field generated by each magnet in each coil side (the sign formed of “x” in a circle designates a direction from the obverse side toward the reverse side in the paper surface in the drawings, and the sign formed of “∘” in a circle designates a direction from the reverse side toward the obverse side in the paper surface in the drawings).

As described above, each of the magnets 19F and 19T adopts the two-pole polarization arrangement. Consequently, for example, parts contributing to a drive in the focusing direction are areas shown as hatched areas in the long sides 13 in the focus coil 12F shown in FIG. 4. Thereby the driving force F_{f1} and the driving force F_{f2} in the z-axis direction are severally generated. That is, a half part or more (hatched areas) of the coil 12F, which is conducted at the time of a focus drive, can be utilized as an effective part for the drive, and consequently the driving force “F_{f1}+F_{f2}” can be effectively generated. Incidentally, when the drive current flows in the direction indicated by the arrow “i” in FIG. 4, a current flowing in a reverse direction in each of the long sides 13 with regard to they-axis direction. Because the direction of the magnetic field in each of the long sides 13 is reverse to each other, the driving force F_{f1} and F_{f2} in the hatched areas has the same directions, and the sum (resultant force) of the driving force F_{f1} and the driving force F_{f2} becomes the total driving force in the focusing direction (when the currents severally flow in reverse directions, the direction of the resultant force becomes reverse).

As to the drive in the tracking direction, as shown in FIG. 5, when a drive current of the tracking coil 12T flows in the direction indicated by the arrows “i”, driving force F_{TRK1} and driving force F_{TRK2} are generated in the hatched areas in the long sides 14 elongated in the z-axis direction. That is, a current flows in a reverse direction in each of the long sides 14 with regard to the z-axis direction. Because the direction of the magnetic field of each of the long sides 14 is reverse to each other, the driving force F_{TRK1} and the driving force F_{TRK2} have the same directions (the same direction in the y-axis direction), and the sum (resultant force) of the driving force F_{TRK1} and the driving force F_{TRK2} becomes the driving force in the tracking direction. A half or more part of the coil 12T can be utilized for the drive.

As described above, by adopting the arrangement in which each magnetic pole of the magnets 19F and 19T having the two-pole polarization corresponds to each of the coil sides of the driving coils 12F and 12T, the effective lengths contributing to the pieces of driving force F_{f1}, F_{f2}, F_{TRK1} and F_{TRK2} of the coils 12F and 12T can be sufficiently secured, and the higher so-called effective rate can be obtained.

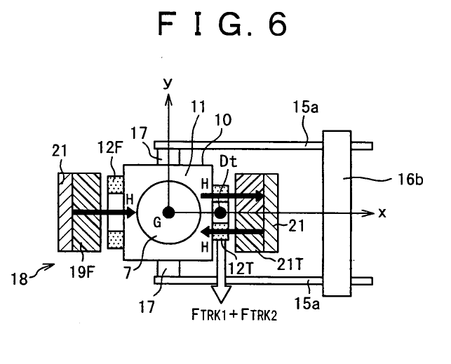

Next, FIGS. 6 to 11 will be referred to while a drive in the tracking direction is described. When a rotational motion other than a translation motion in they-axis direction is added to the driving force F_{TRK1} and the driving force F_{TRK2} in the tracking direction, there is a possibility that a relation (transfer function) of the moving distance of a (beam) spot in the tracking direction to a tracking drive voltage is apart from a characteristic which should be essentially exist. To put it concretely, when resonance in the rotating direction is produced, disorders are generated in a phase characteristic and a gain characteristic of the transfer function. When the disorders are generated at a frequency in the vicinity of a cut-off frequency of servo control, there can be a case where the servo control becomes unstable. Generally, as described above, the centers (the centers of drive) of the pieces of driving force F_{f1}+F_{f2}, and F_{TRK1}+F_{TRK2} and the center of gravity G are made to accord with each other as much as possible in order not to generate such a rotation mode other than the translation motion with regard to the drive in the tracking direction.

A rotation around the z-axis and a rotation around the x-axis can be considered as the rotations which become problems with regard to the drive in the tracking direction.

First, the rotation around the z-axis will be described. In the lens drive apparatus 6 according to the present invention, the center of gravity G and a driving center of the movable section 10 are positioned with a shift between them in the x-axis direction as seen from the optical axis direction of the lens 7. That is, as shown in FIG. 6 as seen from the z-axis direction, the center of gravity G and the driving center (hereinafter designated by a mark “Dt”) in the tracking direction of the movable section 10 of an objective lens driving actuator are located at different positions in the x-axis direction, and the value of the x-coordinate of the center of gravity G and the value of the x-coordinate of the driving center Dt do not accord with each other. Consequently, a rotation mode is generated around the z-axis taking the center of gravity G as the center of the rotation.

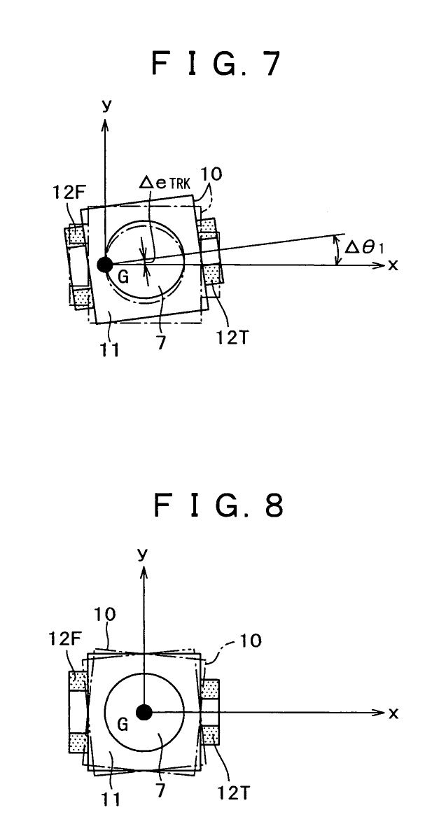

FIG. 7 is a view for illustrating the state, and shows a case where the center of gravity G is shifted from the optical axis of the lens 7. When a distance between the center of gravity G and the optical axis in an x-y plane is designated by a mark “d1” and an angular amplitude of the rotation mode is designated by a mark “Δθ1”, a moving distance “Δe_{TRK}” of a spot after transmission of the objective lens 7 in the rotation mode can be expressed as follows by the use of a sine function “sin”.

Δe_{TRK}=d1×sin Δθ1 Formula (1)

When the z-axis (the axis of inertia) passing through the center of gravity G accords with the optical axis of the lens 7 as shown in FIG. 8, the distance d1 becomes zero, and the moving distance Δe_{TRK} becomes zero. Incidentally, a rotation mode around the z-axis is actually generated in this case, the resonance thereof does not influence on a movement of a spot or the tracking error in the tracking direction, and thereby a stable tracking servo control state can be held.

As described above, by making the axis of inertia passing through the center of gravity G of the movable section 10 accord with the optical axis of the lens 7, the influence owing to resonance can be suppressed even if a rotation or a vibration around the axis of inertia is generated.

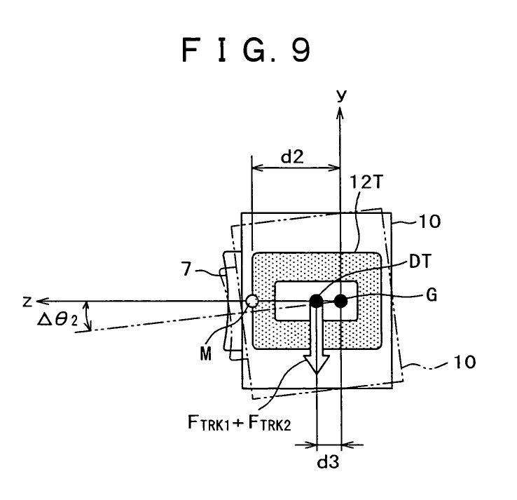

Next, the rotation around the x-axis is described with reference to FIG. 9. When the z-coordinate value of the center of gravity G and the z-coordinate value of the driving center Dt accord with each other, only a translation motion into the tracking direction exists. When both the z-coordinate values do not accord with each other, a rotation mode taking the center of gravity G as its center is generated. When the angular amplitude of the rotation mode is designated by “Δθ2” and a distance between the center of gravity G and a principal plane of the objective lens 7, namely a plane which includes a principal point “M” of the objective lens 7 and is perpendicular to the z-axis direction (the principal point in this case is a principal point on the image side which is positioned at a farther position from the disk 2) is designated by “d2” in the z-axis direction, the moving distance “Δe_{TRK}” of a spot after the transmission through the objective lens 7 owing to the rotation mode becomes the following formula.

Δe_{TRK}=d2×sin Δθ2 Formula (2)

In FIG. 9, a reference mark “d3” designates a distance between the center of gravity G and the driving center Dt in the z-axis direction. By making each of the z-coordinates of the center of gravity G and the driving center Dt accord with each other, the rotation mode around the x-axis can be suppressed, and thereby a state of a stable tracking servo control can be held.

As described above, by according the optical axis of a lens 7 with the axis of inertia (the z-axis), the present invention devises not to generate any movements of a spot in the tracking direction to be caused by a rotation mode generated around the z-axis, which is generated by shifting the center of gravity G of the movable section 10 from the driving center Dt in the x-axis direction. Moreover, as to the rotation mode around the x-axis, by designing in order to accord the coordinates of the driving center Dt and the center of gravity G with each other in the z-axis direction, namely by designing in order that the z-coordinate values of the center of gravity G and the driving center Dt may be equal or almost equal, the present invention devises in order not to generate the rotation mode around the x-axis.

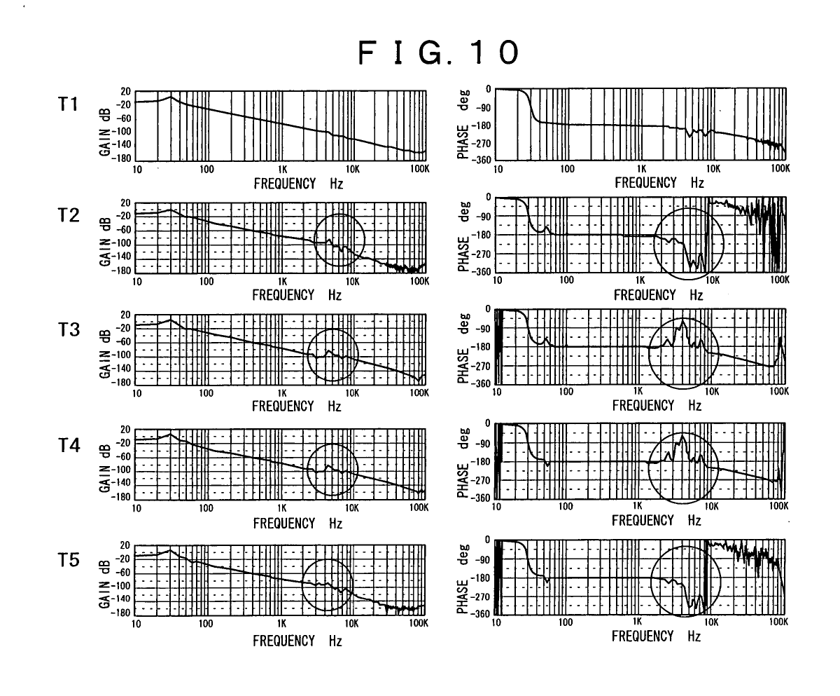

FIG. 10 shows an example of measurement results of transfer characteristics (gain characteristics and phase characteristics) pertaining to the tracking direction. On the left side of the drawing, the gain characteristics are shown. On the right side of the drawing, the phase characteristics are shown. The inputs are set to be drive voltages in the tracking direction, and the outputs are set to be displacement in the tracking direction.

Reference marks “T1” to “T5” in this figure means points of measurement set on the movable section 10. As shown in FIG. 3B, the point of measurement T1 is set at the center of a side surface of the principal piece (bobbin) 11 in the x-z plane, and the points of measurement T2 to T5 are severally set at four corners of the side surface (the point of measurement T2 is positioned at an upper right corner of the point of measurement T1, the point of measurement T5 is positioned at a bottom right corner of the point of measurement T1, the point of measurement T3 is positioned at an upper left corner of the point of measurement T1, and the point of measurement T4 is positioned at a bottom left corner of the point of measurement T1, as seen from the y-axis direction).

In FIG. 10, graph diagrams showing transfer characteristics at the points of measurement T1, T2, T3, T4 and T5 are arranged in the order from the upper row to the lower row.

In the drawing, as to resonance enclosed by a circle in the vicinity of 4 kHz, the phase of the resonance at the points of measurement T2 and T5 are almost the same, and the phase of the resonance at the points of measurement T3 and T4 are almost the same. Moreover, phase relations between the resonance at the points of measurement T2 and T5, and the resonance at the points of measurement T3 and T4 are almost the opposite phases. Consequently, the resonance can be seen to be around the z-axis. On the other hand, in the phase relations between the resonance at the points of measurement T2 and T3, and between the resonance at the points of measurement T4 and T5, some vibrations having the same directions, i.e. vibrations around the x-axis, can be seen at frequencies over 50 Hz. These vibrations are suppressed to be within an allowable level.

As the results, by according each z-coordinate value of the driving center Dt of the tracking direction and the center of gravity G with each other, it can be seen that, even if the x-coordinates of the driving center Dt and the center of gravity G are shifted from each other, the rotation mode around the x-axis can be suppressed.

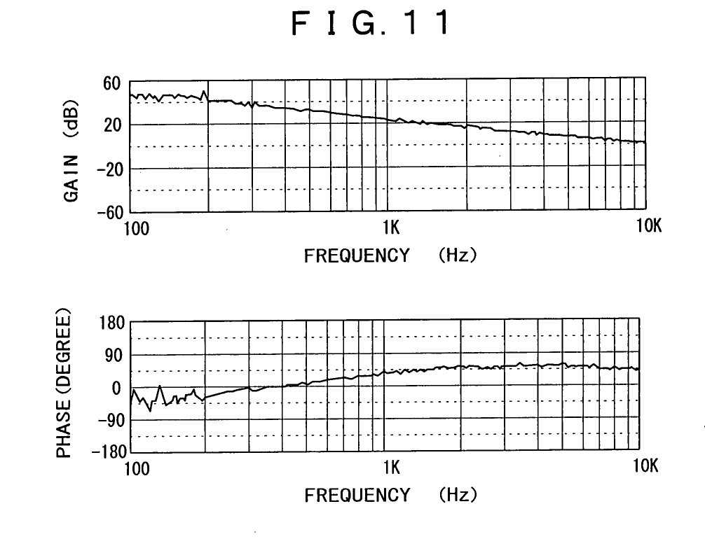

FIG. 11 illustrates open-loop transfer functions when tracking servo control is applied. FIG. 11 is a group of views (Bode diagrams) showing a gain characteristic at the upper row and a phase characteristic at the lower row. Incidentally, inputs are set to be drive voltages in the tracking direction, and outputs are set to be tracking errors.

It is seen that the resonance owing to the rotation mode around the z-axis, which is seen in FIG. 10, generates no variations of a spot in the tracking direction on the basis of no influence of the resonance in the vicinity of 4 kHz and the accordance of the optical axis with the axis of inertia. Thereby, by removing bad influence caused by unnecessary resonance in the drive control in the tracking direction, stable tracking servo control can be realized.

Now, because the moving distance of a spot when the z-coordinates of the driving center Dt in the tracking direction and the center of gravity G do not accord with each other can be expressed by the above-mentioned Formula (2): “Δe_{TRK}=d2×sin Δθ2”, the distance d2 may be set to be zero for making the moving distance of the spot zero. That is, for preventing the generation of any movements of a spot in the tracking direction, even if a rotation mode around the x-axis is generated, it is possible to make the resonance exert no influence on tracking errors by according the z-coordinates of the center of gravity G and the principal point of lens M with each other. Incidentally, this is based on a nature such that a spot position does not move in case of a lens rotation around the principal point M as its center.

As described above, by designing the movable section 10 in order that the x, y, z-coordinate values of the principal point M and the center of gravity G of the lens 7 may be equal or almost equal, the influence of resonance can be evaded. When it is considered that almost all of the rotational vibration modes are generated around the center of gravity Gas their centers, a rotation mode around the principal point M as its center is generated in the above-mentioned case, and there are no cases where the spot position changes greatly in the above-mentioned mode.

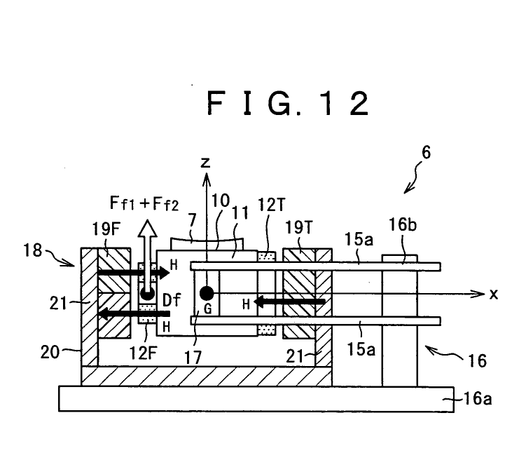

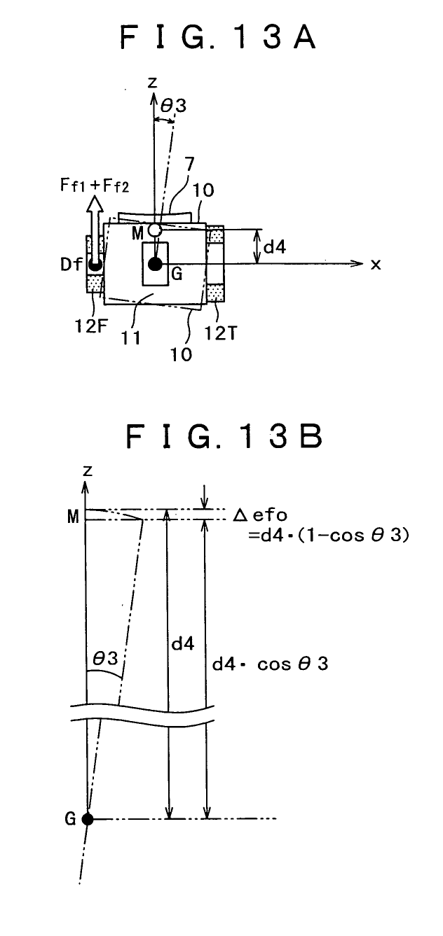

Next, FIGS. 12-17 are referred to while a drive in the focusing direction is described. When a driving center of the focusing direction is designated by a reference mark “Df”, as shown in FIG. 12 as seen from the y-axis direction, the driving center Df and the center of gravity G are in a positional relation to be shifted from each other on the x-axis, and the x-coordinates of them do not accord with each other. In this case, a rotation mode around the y-axis exists. As shown in FIGS. 13A and 13B, when a rotation angle at the maximum amplitude in the rotation mode is designated by a reference mark “θ3”, and when a distance between the center of gravity G and the principal plane of the lens in the z-axis direction is designated by a reference mark “d4”, because rotations occur around the center of gravity G as their centers, the position of the principal point M is shifted by “Δe_{fo}” expressed by the following formula in the z-axis direction owing to the rotation mode (see the schematic diagram shown in FIG. 13B)

Δe_{fo}=d4×(1−cos θ3) Formula (3)

Incidentally, the mark “cos” in the Formula (3) designates a cosine function. The Formula (3) means that, when a rotation around the y-axis by θ3 occurs at the distance d4 in the z-axis direction, a moving distance of a spot (a moving distance of a focus spot) obtained by subtracting d4×cos θ3 from d4 occurs in the z-axis direction.

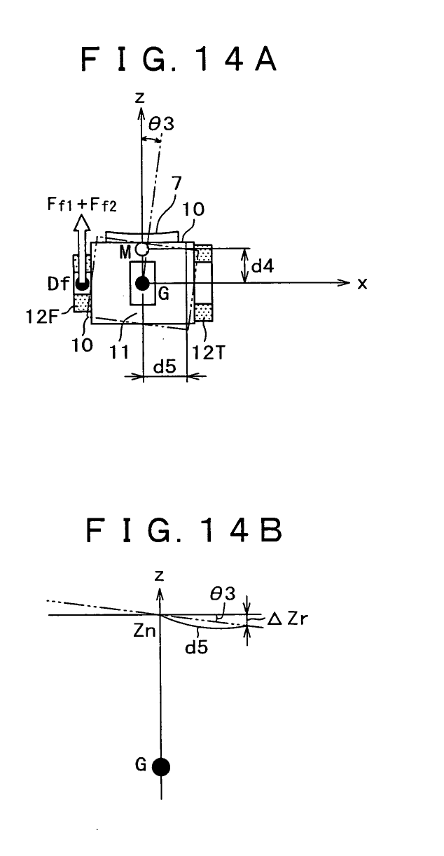

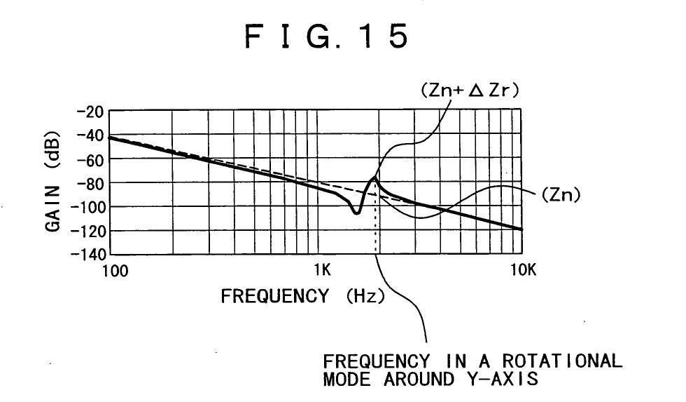

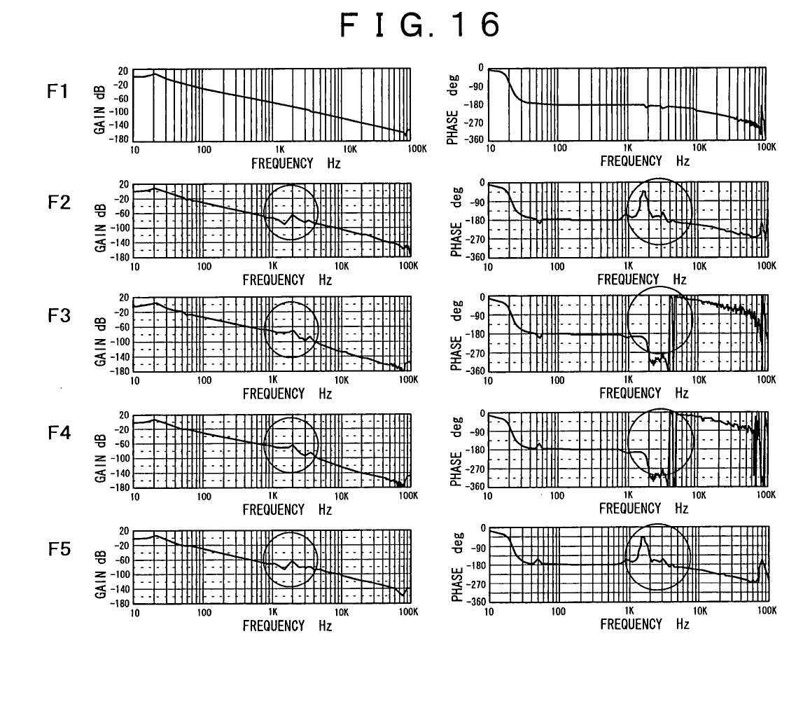

FIGS. 14A, 14B and 15 are views for illustrating the relation between a translation motion in the focusing direction and the rotation mode around the y-axis. FIG. 14A shows the movable section 10 as seen from the y-axis direction, and FIG. 14B shows an amplitude in the rotating direction thereof. FIG. 15 exemplifies again characteristic in the focusing direction.

When a supposed amplitude at the time of supposition of no essential existence of resonance in case of a drive in the focusing direction at the resonance frequency in a rotation mode around the y-axis is designated by a reference mark “Zn”, and when the rotation angle of the rotation mode is designated by the reference mark “θ3” as described above, the following relation can be obtained by supposing that an amplitude variation in the rotating direction observed at a position of the movable section 10 corresponding to “x=d5” is designated by a reference mark ΔZr (see the schematic diagram shown in FIG. 14B).

$$\begin{matrix}θ 3 = {sin}^{- 1} ( Δ Zr / d5 ) \\ \approx Δ Zr / d5\end{matrix} \qquad Formula ( 4 )$$

Incidentally, the mark “sin⁻¹” designates an inverse sine function. The above formula means that a point set at x=d5 at the resonance frequency Zn is displaced by the amplitude variation ΔZr in the z-axis direction owing to the rotation around the y-axis by θ3. The above formula uses an approximation such that the amplitude variation ΔZr is sufficiently smaller than d5.

When a ratio between the amplitude Zn in the essential translation direction and the variation ΔZr in the rotation mode is designated by a reference mark “α” (namely, “ΔZr=α×Zn”), the moving distance “Δe_{fo}” of the focus spot can be obtained as follows from the above-mentioned Formulae (3) and (4).

$$\begin{matrix}Δ {e}_{fo} = d4 \times ( 1 - cos ( Δ Zr / d5 ) ) \\ = d4 \times ( 1 - √ ( 1 - {sin}^{2} ( Δ Zr / d5 ) ) ) \\ \approx d4 \times ( 1 - ( 1 - 0.5 \times {sin}^{2} ( Δ Zr / d5 ) ) \\ \approx d4 \times ( 0.5 \times {( Δ Zr / d5 )}^{2} ) \\ = 0.5 \times {( Δ Zr )}^{2} \times d4 / {( d5 )}^{2}\end{matrix} \qquad Formula ( 5 )$$

Alternatively, a formula using the reference mark α, “Δe_{fo}/Zn=(0.5×α²×Zn×d4)/(d5)²” can be obtained.

The degree of an order quantity of Δe_{fo} to the amplitude Zn of an actual translation motion in the focusing direction will be estimated in the following concrete examples.

FIG. 16 exemplifies transfer characteristics (gain characteristics and phase characteristics) pertaining to the focusing direction. FIG. 16 shows transfer functions having drive voltages in the focusing direction as their inputs and displacement in the focusing direction as their outputs. FIG. 16 is based on measured values at the points of measurement F1 to F5 shown in FIG. 3A. Incidentally, as shown in FIG. 3A, the point of measurement F1 is set at the center of a side surface of the principal piece (bobbin) 11 in the x-y plane, and the points of measurement F2 to F5 are severally set at the four corners of the side surface (the point of measurement F2 is positioned at an upper right corner of the point of measurement F1, the point of measurement F5 is positioned at a bottom right corner of the point of measurement F1, the point of measurement F3 is positioned at an upper left corner of the point of measurement F1, and the point of measurement F4 is positioned at a bottom left corner of the point of measurement F1, as seen from the z-axis direction).

In FIG. 16, graph diagrams showing transfer characteristics at the points of measurement F1, F2, F3, F4 and F5 are arranged in the order from the upper row to the lower row. In the drawing, as to resonance enclosed by a circle in the vicinity of 2 kHz, the phase of the resonance at the points of measurement F3 and F4 vibrates in the same phase, and the phase of the resonance at the points of measurement F2 and F5 vibrates in the same phase. Moreover, phase relations between the resonance at the points of measurement F3 and F4, and the resonance at the points of measurement F2 and F5 are opposite phases. Consequently, it can be seen that the resonance is caused in a rotation mode around the y-axis.

In the present embodiment, when the degree of influence of the actual rotation mode around the y-axis to a focus error signal is evaluated, because the displacement in the focusing direction is about 0.3 mm at 40 Hz, the amplitude Zn (the amplitude of the translation motion in the focusing direction) in the vicinity of 2 kHz at which the rotation mode exists takes the following value.

Zn=(40/2000)²×0.3=1.2×10⁻⁴ (mm)

Because the Q value of the resonance of the amplitude in the rotation mode is about 20 decibel (dB) even when it is evaluated to be largest, the ratio α is set to be 10. Moreover, in the present embodiment, because the distance d5 is 2.5 (mm) and the distance d4 is 1.5 (mm), the following value can be obtained as the ratio of Δe_{fo} to the amplitude Zn on the basis of the values of α, d4 and d5.

$$\begin{matrix}Δ {e}_{fo} / Zn = 0.5 \times {α}^{2} \times Zn \times d4 / {( d5 )}^{2} \\ = 0.5 \times 10 \times 1.2 \times {10}^{- 4} \times 1.5 / {( 2.5 )}^{2} \\ = 0.00144\end{matrix}$$

That is, the Δe_{fo} is about 1/1000 of the amplitude Zn of the translation motion in the focusing direction, and it is seen that the Δe_{fo} is sufficiently small. Consequently, it is seen that the rotation mode around the y-axis does not influence on the actual focus errors.

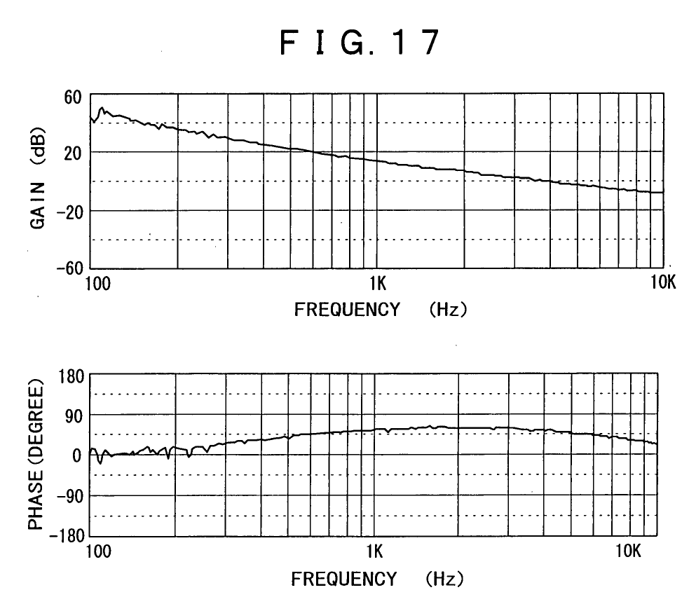

FIG. 17 shows measured examples of open-loop transfer functions when a focus servo control is applied. FIG. 17 is a group of views (Bode diagrams) showing a gain characteristic at the upper row and a phase characteristic at the lower row. No influence of the rotation mode in the vicinity of 2 kHz appears, and consequently stable focus servo control can be realized.

Incidentally, when the distance d4 is zero in the Formula (3), namely when the principal point M of the objective lens 7 and the center of gravity G of the movable section 10 accord with each other, it is seen that the “Δe_{fo}” becomes 0 and that the rotation mode does not influence to the actual focus errors at all. That is, when the x, y, z-coordinate values of the principal point M and the center of gravity G are made to be equal respectively, the focus spot position does not move even when a rotation around the y-axis with the principal point M being the center of the rotation.

The design for according the principal point M with the center of gravity G is not always possible (for example, in a configuration using a short wavelength laser, the position of the principal point M is near to the top surface on the side of the disk 2 of a coil bobbin. Consequently, the design thereof becomes difficult.) However, because the Δe_{fo} becomes smaller as the distance d4 is nearer to zero in the Formula (3), it is preferable to design the differences among x, y, z-coordinate values of the principal point M and the center of gravity G to be sufficiently small by bringing the principal point M close to the center of gravity G as near as possible.

By adopting the above-mentioned configuration form, the following advantages can be obtained. That is, a) an objective lens driving apparatus (actuator) having a small shape and a simple structure can be realized. As a result, high order complex resonance frequencies represented by second order resonance can be made to be high. And further, b) because the efficiency of use of a magnetic field is high, thrust per unit power consumption can be set to be high. Alternatively, when the thrust necessary for a drive is set to be the same degree, the power consumption necessary for servo control can be decreased in comparison with the conventional configuration.

Still further, c) a cut-off frequency on a servo control can be set to be high, more precise focus servo control and tracking servo control can be realized.

Still further, d) in the configuration described above, an example in which a focus coil and a tracking coil are severally annexed on each of two side surfaces perpendicular to the x-axis in the movable section has been shown. However, the application of the present invention is not limited only to such a configuration. That is, as long as the center of gravity of the movable section and the driving center of the tracking direction or the focusing direction have a positional relation to be shifted from each other in the x-axis direction, the following configuration may be adopted. For example, a configuration form in which a tracking coil and a focus coil are attached on the same side surface of a movable section along the z-axis direction, (which is advantageous for miniaturization and an arrange space in a configuration using a plurality of objective lens drive apparatus), and the like can be adopted. Because such a configuration is not necessary for according the center of gravity of the movable section and the driving center with each other, the configuration is released from the limitation on design and has a high freeness on its structure. Moreover, the present invention can be widely applied to drive apparatus of various lens systems (an aberration correction lens and the like) in addition to the objective lens.

Incidentally, in case of the above-mentioned form (II), the positional relation between the driving coil and the magnetic field means is reverse to that of the form (I). Consequently, in case of the form (II), the above description can be applied to the case by replacing the driving coil with the magnetic field means and vice versa to be interpreted while being suitably changed (the basic matters pertaining to the present invention are not changed).

What is claimed is:

1. A less drive apparatus having a movable section which is equipped with a plurality of either drive coils or magnetic field means for moving a mounted lens to an optical axis direction and a moving direction orthogonal to said optical axis direction and a fixed section for supporting said movable section and having either magnetic field means for said drive coils or drive coils for said magnetic field means, wherein:
an x-coordinate value of a center of gravity G and an x-coordinate value of a driving center Df do not accord with each other, provided that a z-axis is set to pass through the center of gravity of the movable section in a direction parallel to the optical axis, a y-axis is set in said moving direction of the lens, an x-axis is set in a direction orthogonal to the z-axis and the y-axis, the center of gravity of said movable section is G, and a driving center of the movable section in the z-axis direction is Df.

2. The lens drive apparatus as cited in claim 1, wherein:
z-coordinate value of the center of gravity G and z-coordinate value of the driving center Dt are approximately equal, provided that a driving center of said movable section to y-axis direction is defined as Dt.

3. The lens drive apparatus as cited in claim 1, wherein:
a principal point of said lens and the center of gravity G of said movable section approximately accord wit each other.

4. The lens drive apparatus as cited in claim 1, wherein:
said plurality of drive coils includes drive coils for the lens in the optical axis direction and drive coils for the lens in the moving direction; and
respective said magnetic field means provided to each of said drive coils for the lens in the optical axis direction and drive coils for the lens in the moving direction are arranged across said lens.

5. An optical head apparatus having an optical system including an objective lens and a light source for reading and/or recording of an optical recording medium, a movable section which is equipped with a plurality of either drive coils or magnetic field means for moving said objective lens to an optical axis direction and a moving direction orthogonal to said optical axis direction and a fixed section for supporting said movable section and having either magnetic field means for said drive coils or drive coils for said magnetic field means, wherein:
an x-coordinate value of a center of gravity G and an x-coordinate value of a driving center Df do not accord with each other, provided that a z-axis is set to pass through the center of gravity of the movable section in a direction parallel to the optical axis, a y-axis is set in said moving direction of the objective lens, an x-axis is set in a direction orthogonal to the z-axis and the y-axis, the center of gravity of said movable section is G, and a driving center of the movable section in the z-axis direction is Df.

6. The optical head apparatus as cited in claim 5, wherein:
z-coordinate value of the center of gravity G and z-coordinate value of the driving center Dt are approximately equal, provided that a driving center of said movable section to y-axis direction is defined as Dt.

7. The optical head apparatus as cited in claim 5, wherein:
a principal point of said lens and the center of gravity G of said movable section approximately accord with each other.

8. The optical head apparatus as cited in claim 5, wherein:
said plurality of drive coils includes drive coils for the objective lens in the optical axis direction and drive coils for the objective lens in the moving direction; and
respective said magnetic field means provided to each of said drive coils for the lens in the optical axis direction and drive coils for the objective lens in the moving direction are arranged across said objective lens.

9. An optical disk drive apparatus having an optical system including an objective lens and a light source for reading and/or recording of an optical recording medium rotated by rotating means, a movable section which is equipped with either focus coil and tracking coil or focus magnetic field means and tracking magnetic field means for moving said objective lens to an optical axis direction and a tracking direction orthogonal to said optical axis direction and a fixed section for supporting said movable section and having either focus magnetic field means and tracking magnetic field means for said focus coil and said tracking coil or focus coil and tracking coil for said focus magnetic field means and said tracking magnetic field means, wherein:
an x-coordinate value of a center of gravity G and an x-coordinate value of a driving center Df do not accord with each other, provided that a z-axis is set to pass through the center of gravity of the movable section in a direction parallel to the optical axis, a y-axis is set in said moving direction of the objective lens, an x-axis is set in a direction orthogonal to the z-axis and the y-axis, the center of gravity of said movable section is G, and a driving center of the movable section in the z-axis direction is Df.

10. The optical disk drive apparatus as cited in claim 9, wherein:
z-coordinate value of the center of gravity G and z-coordinate value of the driving center Dt are approximately equal, provided that a driving center of said movable section to y-axis direction is defined as Dt.

11. The optical disk drive apparatus as cited in claim 9, wherein:
a principal point of said lens and the center of gravity G of said movable section approximately accord with each other.

12. The optical disk drive apparatus as cited in claim 9, wherein:
said focus coil and tracking coil, and said focus magnetic field means and said tracking magnetic field means provided for said focus coil and said tracking are arranged across said objective lens.
